(19) United States
(12) Patent Application Publication
(10) Pub. No.: US 2023/0031557 A1
(43) Pub. Date: Feb. 2, 2023

(54) DEVICE AND METHOD FOR MODULAR MATERIAL TRANSPORT

(71) Applicant: DoDads Design LLC, Virginia Beach, VA (US)

(72) Inventors: James Hilbert, Virginia Beach, VA (US); Jason Park, Virginia Beach, VA (US); Bryan Rother, Cambridge, MA (US)

(21) Appl. No.: 17/390,978

(22) Filed: Aug. 1, 2021

(51) Int. Cl. B62D 63/06

(52) U.S. Cl. CPC B62D 63/061

(57) ABSTRACT

Disclosed are various embodiments a track and frame system that may be used for various applications. The track may be attached to a transport that may be interchangeably used with frames for different applications. The track includes locking sliders that are attached to the frame and that slide over the track. The sliders may be locked in position to prevent any movement of the frame relative to the track and may be unlocked for unloading of the frame.

### BACKGROUND

Various transport applications require specialized trailers for each application. For example, a special trailer is needed to tow a boat. A second trailer may be needed for transportation of material, such as lumber. Further, a third trailer may be needed for transportation of a different material, such as dirt, mulch, etc. These different requirements cause an owner to own multiple trailers and store these trailers when not in use. In addition, each trailer needs to comply with the corresponding state, or governmental authority's requirements, such as a separate title, registration, insurance, etc.

This leads to wasted cost, extra storage space, and unnecessary downtime when changing trailers. It would be advantageous if a single trailer could accommodate different applications, thereby reducing the cost of ownership, space for storage, and easy and quick turnaround when changing applications. Further, it would be advantageous to have a system that allows easy loading and unloading, including a quick and easy method to secure the load and an easy method to unload, with a quick disconnect.

### SUMMARY

Various embodiments of the present disclosure include a device including at least one track, the at least one track having a length along a length axis, a height along a height axis, a width along a width axis, an inner surface parallel to the length and height axes, an outer surface parallel to the inner surface, the at least one track having a base portion and a plurality of ridges that extend along the height axis from a top surface of the base portion, wherein a first surface of the base portion is oblique to a bottom surface of the base portion and to the inner surface, and wherein a first surface of each ridge of the plurality of ridges is oblique to the outer surface and to a top surface of that ridge, and a clamping mechanism to removably attach to the at least one track, the clamping mechanism comprising an inner part and an outer part, wherein the outer part, when clamped, is in contact with the first surface and the top surface of at least one ridge, and wherein the inner part, when clamped, is in contact with the first surface of the base portion and the inner surface.

Various embodiments of the present disclosure include a device including a material transport container including at least two openings and at least two support extensions, at least one piston, and a frame comprising at least two support points, wherein the at least one piston is attached to the material transport container and the frame, and wherein the at least two support extensions rest on the at least two support points when the piston is in a closed position.

Various embodiments of the present disclosure include a method of securing a frame to at least one track, the method including: placing the frame over the at least one track, wherein when placed, an outer part attached to the frame is in contact with at least a portion of an outer surface of the at least one track, sliding an inner part after placing the frame on the at least one track, such that the inner part is in contact with at least a portion of an inner surface of the at least one track, and securing the inner part with the frame.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 shows a three-dimensional view of a track attached to a transport with a frame mounted on to the track, according to various example embodiments.

FIG. 2 shows a three-dimensional view of tracks, according to various example embodiments.

FIG. 3 shows a cross-sectional view of tracks, according to various example embodiments.

FIG. 4A shows a perspective view of a portion of a track, according to various example embodiments.

FIG. 4B shows a top view of a portion of a track, according to various example embodiments.

FIG. 5 shows a perspective view of a portion of a track along with a portion of a frame, according to various example embodiments.

FIG. 6 shows a perspective view of a portion of a track along with exemplary mechanisms that allow an inner part of a clamping mechanism to be secured, according to various example embodiments.

FIG. 7 shows a perspective view of a portion of a track along with some exemplary mechanisms that allow an inner part of a clamping mechanism to be secured to a frame, according to various example embodiments.

FIGS. 8A and 8B show a perspective view of a container having two different sized openings that can be used to disburse material in different amounts, according to various example embodiments.

FIG. 9 shows a perspective view of a container that is placed on a frame that is attached to two tracks attached to a transport, according to various example embodiments.

FIG. 10 shows a perspective view of a container that is attached to a piston, showing locking mechanisms that are attached to a frame to selectively operate the container, according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Various aspects of the disclosure are directed to a track system that may be used for various applications. The track system includes one or more tracks, a locking mechanism that slides over the tracks, and a frame. The track may be installed on a bed of a vehicle, such as a pickup truck, or on a trailer that can be towed. The locking mechanism may be attached to the frame. The locking mechanism allows for easy installation of the frame onto the track. Further, the mechanism allows for the frame to be secured onto the track. Various aspects of the disclosure are directed to a container that allows for easy removal of material, such as dirt, mulch, etc. The container may have different dosing applications. Various aspects of the disclosure are directed to a method of loading a frame with a locking mechanism onto a transport with one or more tracks.

In the following paragraphs, the embodiments are described in further detail by way of example with reference to the attached drawings. In the description, well known components, methods, and/or processing techniques are omitted or briefly described so as not to obscure the embodiments. As used herein, the “present invention” refers to any one of the embodiments of the invention described herein and any equivalents. Furthermore, reference to various feature(s) of the “present invention” is not to suggest that all embodiments must include the referenced feature(s).

The embodiments described herein are not limited in application to the details set forth in the following description or illustrated in the drawings. The invention is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “attached,” “connected” and “coupled” are used broadly and encompass both direct and indirect connections and couplings, and can be permanently or removably coupled.

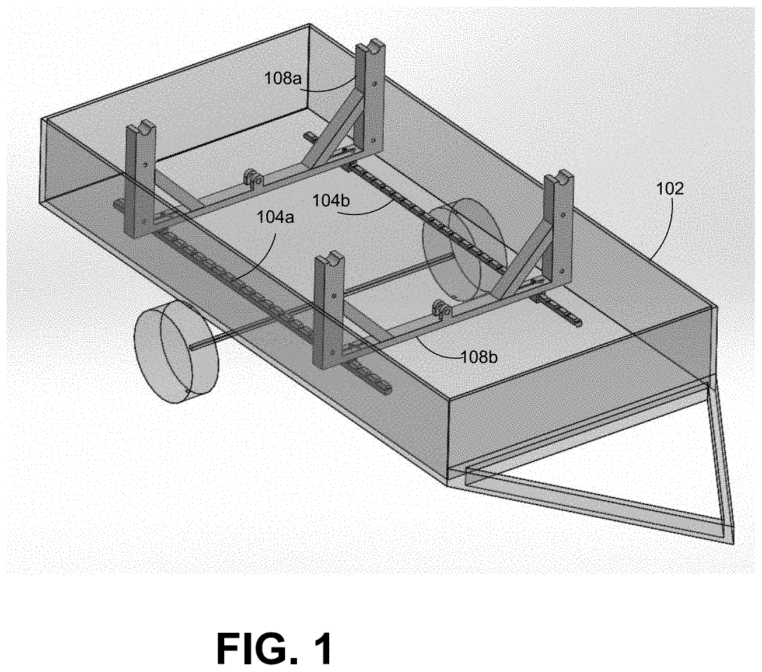

Turning now to the drawings, exemplary embodiments are described in detail. FIG. 1 shows a three-dimensional view of a track attached to a transport with a frame mounted on to the track, according to various example embodiments. FIG. 1 depicts transport 102, which includes tracks 104 and frame 108 mounted on tracks 104a and 104b. Transport 102 in this example is a trailer. Tracks 104a and 104b are attached to a bed of transport 102. Frame 108 is then mounted onto tracks 104a and 104b. In the example of FIG. 1, frame 108 includes two separate members 108a and 108b. Members 108a and 108b may generally be the same and spaced apart to receive something to be transported, such as a container for material, a boat, etc.

Track 104 may be attached to transport 102 without needed to be removed for different applications. Frame 108 may be designed to suit various applications, or may be interchangeably used with other frames, depending on the particular application. This allows a single trailer to be used for various applications, reducing cost of ownership, registration, insurance, etc. This further allows quick and easy loading and unloading, without having to swap out a trailer. Various applications may use frame custom to that particular application. For example, one frame may be used to carry a container, while another may be used to transport a boat. The boat may sit on the frame designed for its transport, and when an owner wished to swap out the container transport application for the boat transport application, the owner may simply remove the frame and container from tracks 104 and load the boat with its specific frame onto tracks 104.

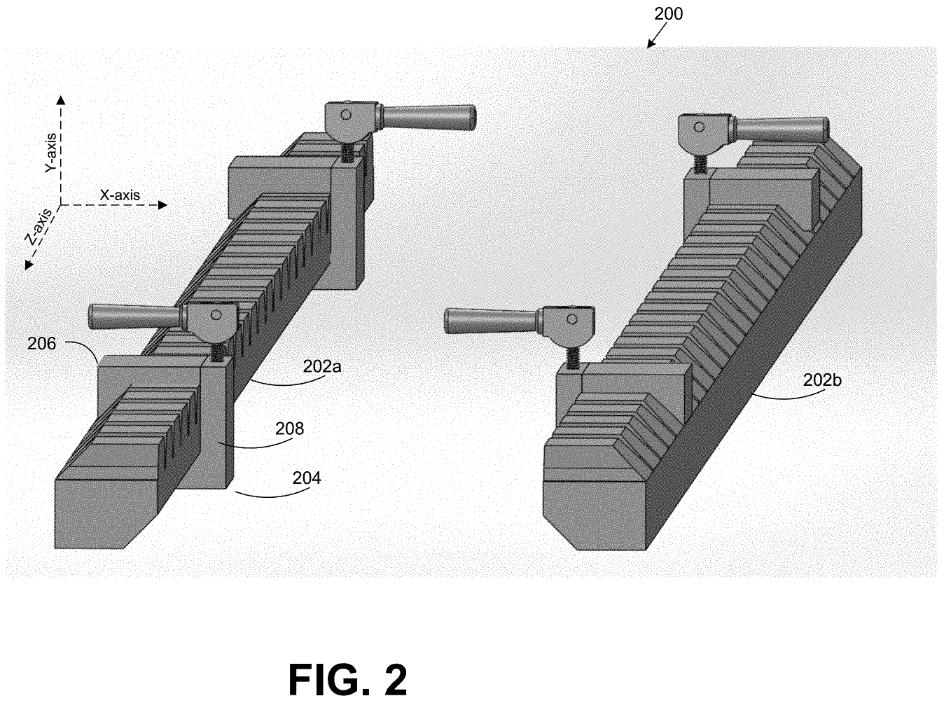

FIG. 2 shows a three-dimensional view of tracks, according to various example embodiments. FIG. 2 depicts tracks 202a and 202b from a different perspective than FIG. 1. Also depicted in FIG. 2 are four clamping mechanisms 204. Clamping mechanism 204 may include outer part 206 and inner part 208. In various example embodiments, tracks 202a and 202b have similar shapes but are attached to a transport such that track 202a and track 202b are arranged to mirror each other in their profile, as seen in FIG. 2. In various example embodiments, clamping mechanism 204 is attached to a frame, such as frame 108 (as seen in FIG. 1). In various applications, tracks 202a and 202b may be installed or attached to a transport. Tracks 202a and 202b may be arranged as shown in FIG. 2, when installed or attached to a transport. The side of tracks 202a and 202b facing each other form the inner sides, whereas the sides that are away from each other form the outer sides.

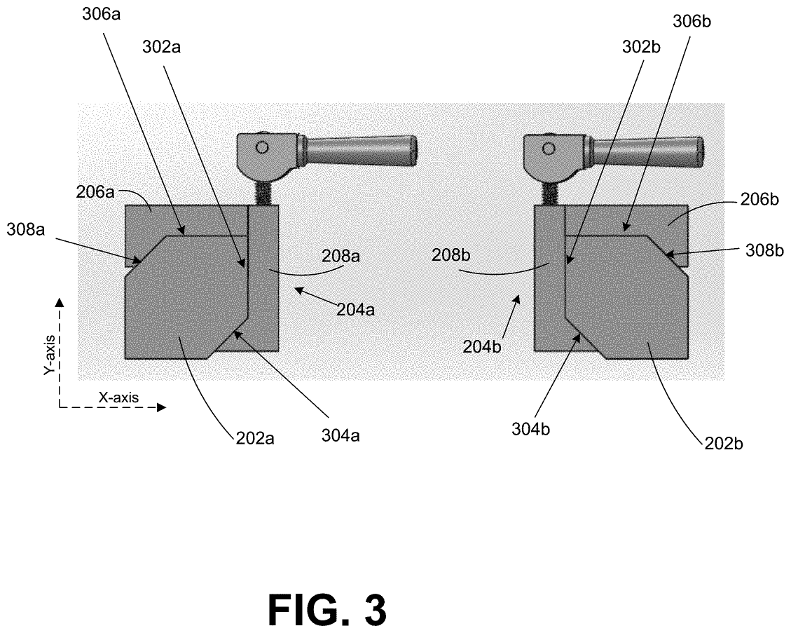

FIG. 3 shows a cross-sectional view of tracks, according to various example embodiments. FIG. 3 depicts a cross-sectional view of tracks 202 (of FIG. 2), along with clamping mechanisms 204 (of FIG. 2) when clamping mechanisms 204 are secured to tracks 202. The cross-section is taken along a plane that contains a height axis (Y-axis in FIGS. 2 and 3) and width axis (X-axis of FIGS. 2 and 3) of tracks 202. FIG. 3 shows tracks 202a and 202b having an inner surface 302a and 302b in contact with inner part 208a and 208b, respectively, of clamping mechanism 204a and 204b, respectively. Tracks 202a and 202b also have an oblique surface 304a and 304b, respectively, that is in contact with an oblique surface of inner part 208a and 208b. Outer part 206a and 206b is in contact with top surface 306a and 306b (of tracks 202a and 202b respectively) and oblique surface 308a and 308b (of tracks 202a and 202b respectively). In various example embodiments, outer part 206 may be rigidly attached to a frame, such as frame 108, while inner part 208 can slide relative to a width axis (X-axis) of track 202. This allows for easy placement of frame 108 on top of tracks 202a and 202b. Outer pars 206a and 206b being rigidly attached to frame allow for the frame to be seated properly on the tracks. The oblique surface (308) on the tracks allows for easy placement of the outer parts that are attached to a frame, as the frame may be moved along the X-axis to center it over tracks 202a and 202b. After the frame and outer parts are seated over tracks 202a and 202b, inner parts 208a and 208b are slid outwards, i.e., towards outer parts 206a and 206b respectively to secure clamping mechanisms 204a and 204b around tracks 202a and 202b. Once the frame is properly seated on the tracks, the oblique shape of the tracks (308a and 308b) and the corresponding oblique shape of the outer part, prevent any movement along the X-axis of the frame. This type of design provides easy of alignment and a fastening mechanism that is advantageous for the various applications described herein.

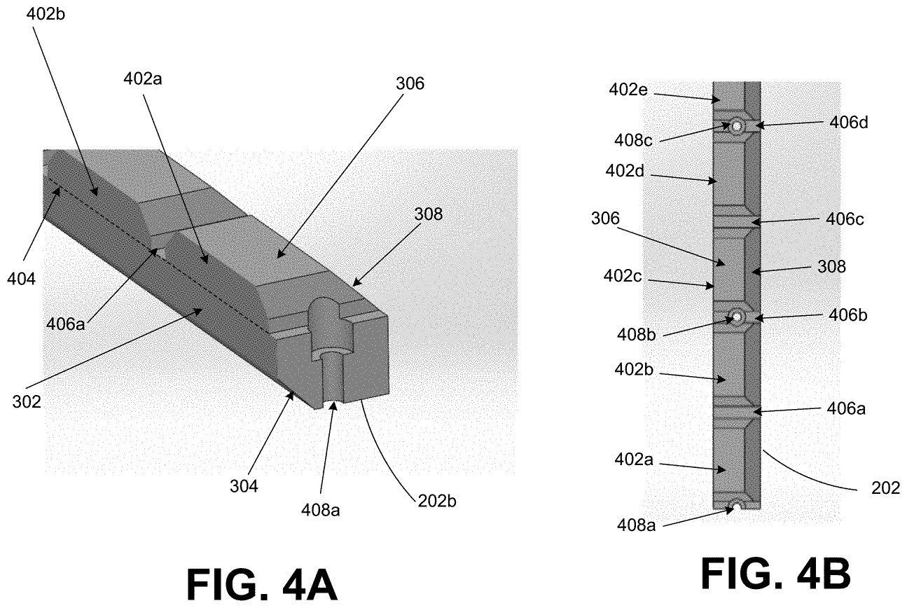

FIG. 4A shows a perspective view of a portion of a track, according to various example embodiments. FIG. 4A depicts a portion of track, such as track 202 (shown in FIGS. 2 and 3). Also shown in FIG. 4A is inner surface 302, oblique surface 304, top surface 306, and oblique surface 308. Further, FIG. 4A shows two ridges 402a and 402b, formed on track 202. In various example embodiments, track 202 has multiple ridges 402 along its length. As can be seen in FIG. 4A, oblique surface 308 is formed on ridge 402's surface. Ridges 402 may be seen as rising from a body portion of track 202. The body portion of track 202 may be considered the part below divider 404 (an imaginary line shown in FIG. 4A), whereas each ridge 402 may be considered as the part above divider 404. Divider 404 is an imaginary line shown in FIG. 4A. Also seen in FIG. 4A is a gap, gap 406a, between ridges 402a and 402b. In various example embodiments, the height of a ridge above divider 404 is about the one-third the total height of the track including the body portion. In various example embodiments, the height of a ridge above divider 404 is about the one-quarter to one-half the total height of the track including the body portion. In various example embodiments, the height of a ridge above divider 404 is about the half inch to one inch and the total height of the track including the body portion is about one and half inch to two and a half inches. In various example embodiments, the height to width ratio of track 202 is about one to one.

Further, track 202 may include an opening, such as hole 408. Hole 408 may be located at intervals along track 202. Further, hole 408 may coincide with gap 406. Hole 408 allows a fastener, such as a screw or bolt to be inserted through track 202 such that track 202 may be attached to a transport. As can be seen in FIG. 4A, hole 408 may by countersunk, having a wider opening and narrower section, to allow for the head of the bolt or screw to be fully inserted into the hole.

FIG. 4B shows a top view of a portion of a track, according to various example embodiments. FIG. 4B depicts track 202, from a top view, showing at least four ridges 402, specifically 402a, 402b, 402c, 402d, and 402e (partial). Also seen in FIG. 4B are at least four gaps 406, specifically, 406a, 406b, 406c, and 406d and three holes 408, specifically 408a, 408b, and 408c. Oblique surface 308 forms from top surface 306 and ends at an outer part of track 202. Additionally, oblique surfaces are also formed starting at top surface 306 and inclining towards a top of the body portion of the track at the gap between the ridges, but the oblique surface does not incline all the way to the gap, as seen in FIGS. 4A and 4B.

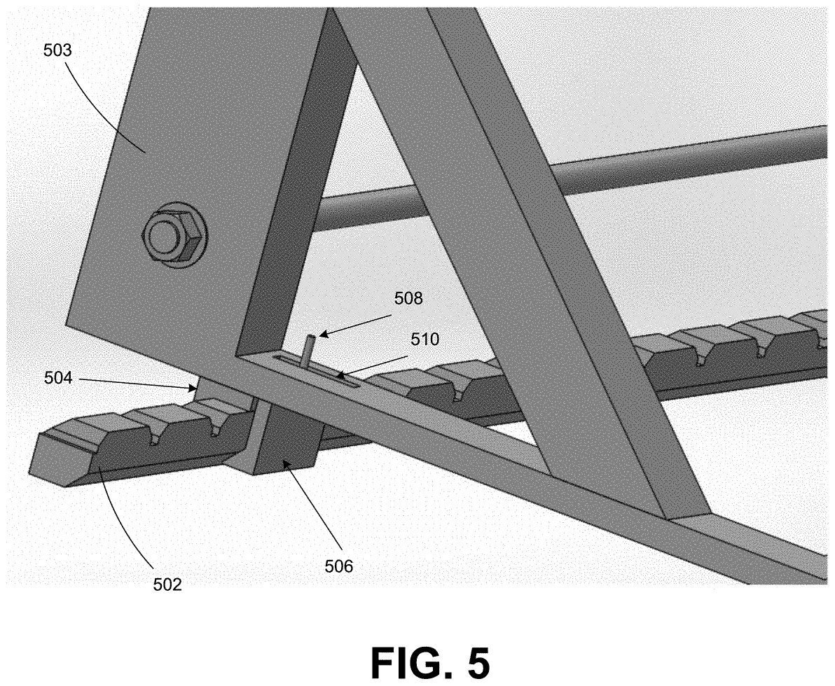

FIG. 5 shows a perspective view of a portion of a track along with a portion of a frame, according to various example embodiments. Shown in FIG. 5 is track 502 and frame 503. Outer part 504 of clamping mechanism is attached to frame 503. Inner part 506 of clamping mechanism includes pin 508 that extends vertically from inner part 506. Inner part 506 may be attached to frame 503 with pin 508 extending out of frame 503 via opening 510 in frame 503. Inner part 506 may slide along the length of opening 510, from an open position further away from track 502 to a closed position in contact with track 502. As will be apparent to those skilled in the art, various mechanisms may be used in conjunction with pin 508 to lock the movement of inner part 506 relative to frame 503 after inner part comes in contact with track 502, thereby locking frame 503 to track 502.

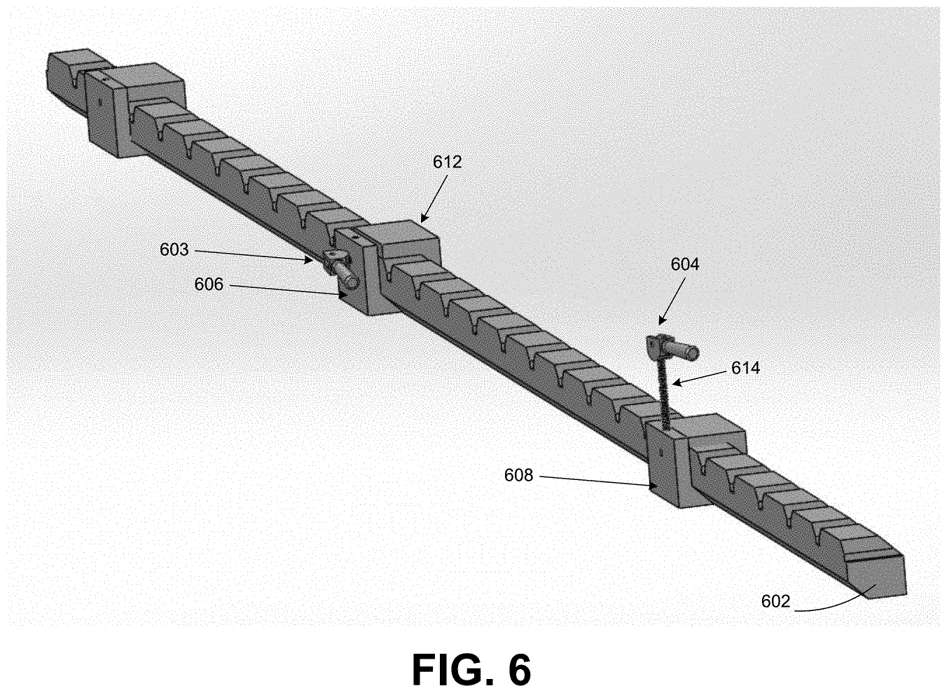

FIG. 6 shows a perspective view of a portion of a track along with exemplary mechanisms that allow an inner part of a clamping mechanism to be secured, according to various example embodiments. FIG. 6 shows a track 602 and two different cam clamps 603 and 604 that may be attached to inner part 606 and 608, respectively. Cam clamp 603 may be attached to a threaded member is that inserted horizontally to inner part 606. In various examples, the threaded member is inserted into inner part 606 and also attaches to outer part 612. The opening in the inner part is greater than the diameter of the threaded member allowing inner part 606 to slide around the threaded member. Cam clamp 603 may then be tightened by pushing inner part 606 closer to outer part 612 and then turning the cam clamp to clamp it tight. Cam clamp 604 may be attached to threaded member 614 that is inserted vertically to inner part 608. Threaded member 614 may be inserted through an opening in a frame, such as opening 510 in frame 503 (shown in FIG. 5), before cam clamp 604 is attached to threaded member 614, thereby loosely attaching inner part 608 to frame 503.

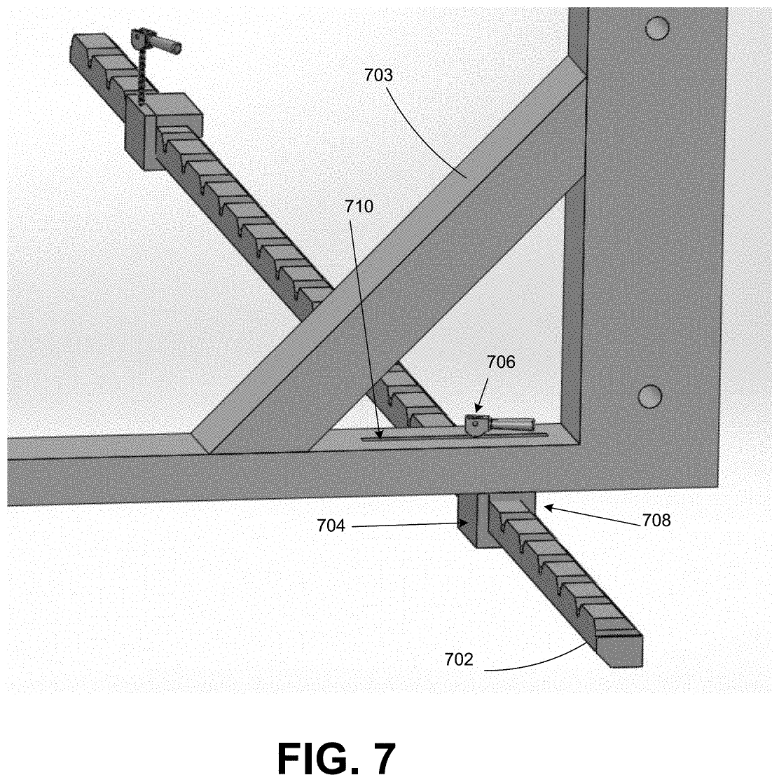

FIG. 7 shows a perspective view of a portion of a track along with some exemplary mechanisms that allow an inner part of a clamping mechanism to be secured to a frame, according to various example embodiments. FIG. 7 shows a portion of track 702 and a portion of frame 703. Inner part 704 is shown attached to frame 703 with cam clamp 706 secured to a threaded member (not shown in FIG. 7). When frame 703 is to be placed on track 702, inner part 704 may be loosely attached to frame 703 by sliding inner part 704 away from outer part 708 and not having cam clamp 706 fully tightened. Frame 703 may then be placed with outer part 708 aligned over track 702. Inner part 704 may then slide such that it is in contact with track 702 and then cam clamp 706 may be tightened.

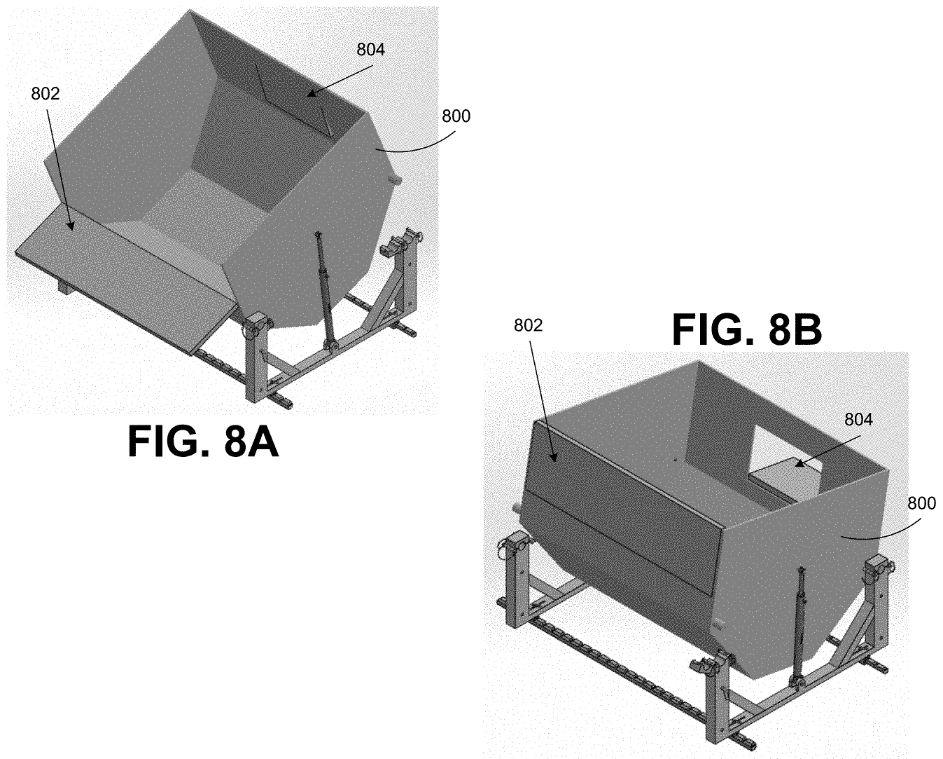

FIGS. 8A and 8B show a perspective view of a container having two different sized openings that can be used to disburse material in different amounts, according to various example embodiments. FIG. 8A shows container 800 that has two different openings, 802 and 804 having two different sizes, in a first position. Opening 802 is on one side of container 800 while opening 804 is on an opposite side of opening 802 on container 800. When container 800 is tilted towards the side having opening 802, as seen in FIG. 8A, material inside container 800 is disbursed at one rate. When container 800 is tilted towards the side having opening 804, as seen in FIG. 8B, the same material inside container 800 is disbursed at a second rate. The rate of disbursement is based on the size of the opening.

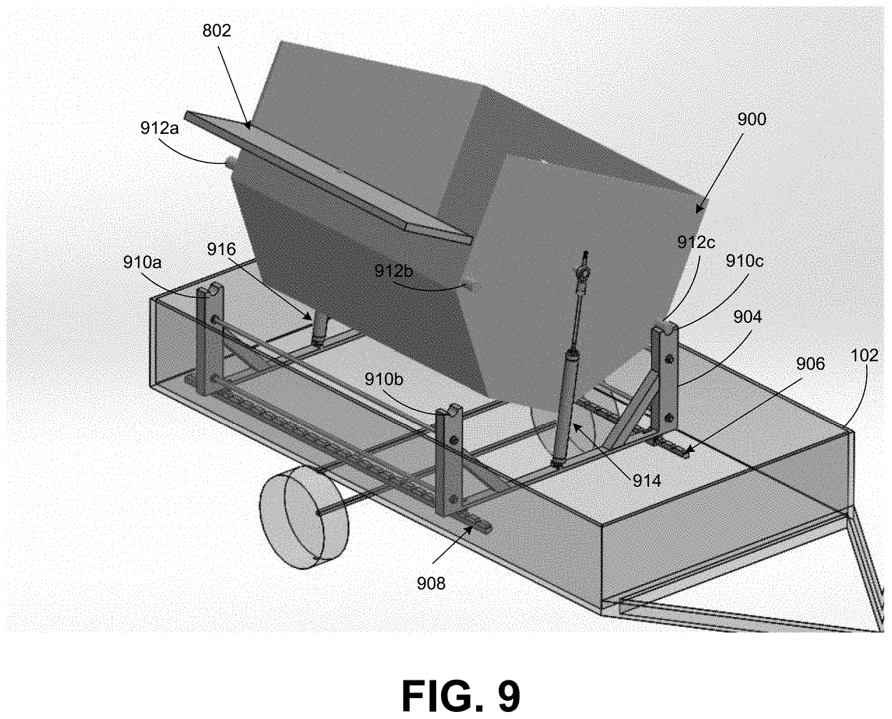

FIG. 9 shows a perspective view of a container that is placed on a frame that is attached to two tracks attached to a transport, according to various example embodiments. Container 900 is placed on frame 904 that is attached to tracks 906 and 908 according to various example embodiments described herein. With container 900 loaded onto frame 903 and tracks 906 and 908, openings 802 and 804 (not shown in FIG. 9) will be on either side of transport 102.

Frame 904 includes four support points on which container 900 may rest. Frame 904 may be a single piece, or it may be made up of multiple pieces that are connected. For example, the frame may consist of a front part and a back part, or a left part and a right part. In some embodiments, the left and right parts may attach to each other and the distance between them may be adjustable to fit different widths between tracks 906 and 908. Further, in some embodiments, the front part and back part may attach to each other and the distance between them may be adjustable to fit different lengths of containers.

Support points 910a-d support four pivot points 912a-d on container 900. Support points may be semi-circular whereas pivot points may be cylindrical protrusions from container 900. Further, one or more pistons may be connected to frame 904 that may be used to operate the container. FIG. 9 shows piston 914 and 916 connected to frame 904 and to container 900. In various example embodiments, piston 914 and 916 may be hydraulically operated, i.e., using a pump that pumps fluid into the piston to extend and contract its arm.

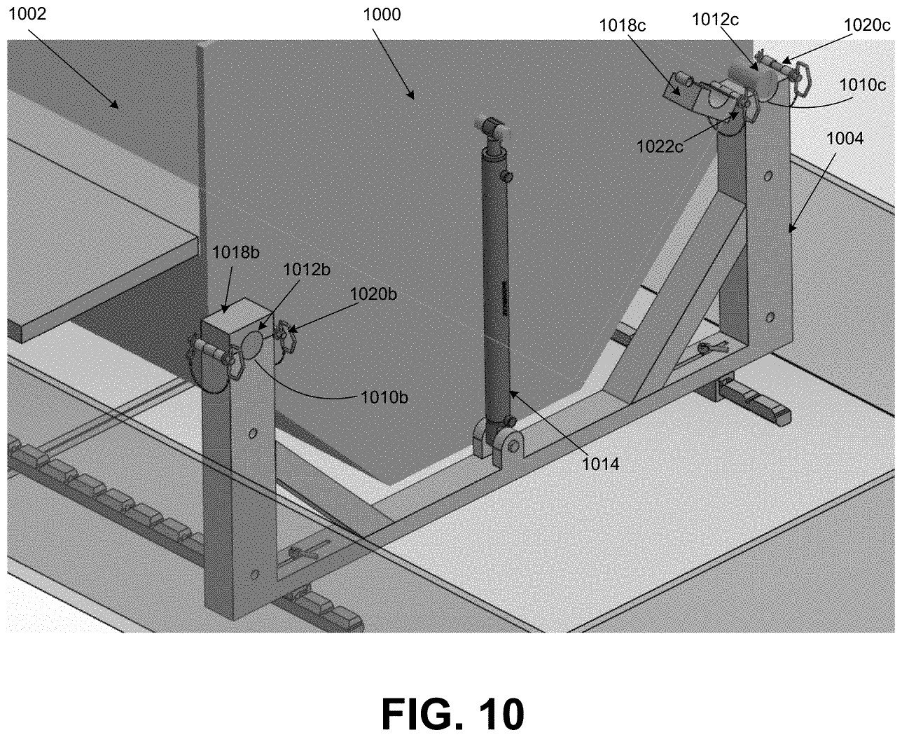

FIG. 10 shows a perspective view of a container that is attached to a piston, showing locking mechanisms that are attached to a frame to selectively operate the container, according to various example embodiments. Container 1000 is shown on frame 1004. FIG. 10 shows only two support points 1010b-c and only two pivot points 1012b-c. As will be apparent to those skilled in the art, two additional support points and two addition pivot points may be present on the frame and container respectively. In order to tilt the container to one side, in this case, the side with opening 1002, support points on the opposite side, i.e., 1010c-d are unlocked, while support points on the same side as opening 1002 are locked. FIG. 10 shows two securing mechanisms 1018b-c at each of the support points 1010b-c. As will be apparent to those skilled in the art, two additional locking mechanisms may be attached to support points 1010a and 1010d. In this case, securing mechanism 1018a and 1018b are locked, such that pivot points 1012a and 1012d cannot move up when pistons 1014 and 1016 are extended, while securing mechanism 1018c and 1018d are unlocked. When the piston extends upwards, due to the pivot points 1012a-b being locked with support points 1010a-b, a tilting motion is caused, while simultaneously lifting container 1000 up from support points 1010c-d. This may cause any material inside container 1000 to be ejected from opening 1002. Opening 1002 may be latched or secured to the body of container 1000 and may need to be unlatched before operating piston to ensure that the flap at opening 1002 will open outwards as container 1000 is lifted upwards and tilts in the direction of opening 1002. Securing mechanism 1018 may be a latch that rotates to close and cover pivot point, as seen for pivot point 1012b. In its closed position, securing mechanism 1018b may be secured by a pin 1020b. To open securing mechanism 1018c, pin 1020c may be removed and securing mechanism 1018c may be rotated about pin 1022c to open in.

Additionally, FIG. 10 also shows piston 1014 attached to frame 1004 at 1030 and to container 1000 at 1032. These two points of contact 1030 and 1032 may allow free rotation of the attachment points with respect to piston 1014, which allows the rotation of container 1000 relative to piston 1014 and rotation of piston 1014 relative to 1004 as it expands.

In various examples, the material that may be transported in a container as described herein, may include, mulch, dirt, rocks, natural and man-made debris, construction debris and trash.

In various examples, frame may be configured to transport a boat, camper, motorcycle, ATV, etc.

In various examples, tracks may be constructed from steel, aluminum, iron, metal alloys, metal composites, plastic, plastic composites, carbon fiber, etc. and may be made by metal machining, metal extrusion, casting, stamping, etc.

In various examples, clamping mechanism such as inner part and outer part may be constructed from steel, aluminum, iron, metal alloys, metal composites, plastic, plastic composites, carbon fiber, etc., and may be made by metal machining, metal extrusion, casting, stamping, plastic molding, etc.

In various examples, frame may be constructed from steel, aluminum, iron, metal alloys, metal composites, plastic, plastic composites, carbon fiber, etc., and may be made by metal extrusion, casting, stamping, metal machining, cutting, welding, etc.

In various examples, container may be constructed from steel, aluminum, iron, metal alloys, metal composites, plastic, plastic composites, carbon fiber, wood, sheet metal. etc., and may be made by metal extrusion, casting, stamping, metal machining, cutting, welding, plastic molding, etc.

In various example embodiments, a container may be interchangeable with a frame. That is one or more containers may be interchangeably used with one or more frames. This allows for containers to be used with different frames and a single frame to be used with different containers. Additionally, in various examples, frames for different applications may be interchangeably used with tracks installed on a transport. This allows for tracks to be permanently installed on a transport and frames to be interchangeable based on application and material/load to be transported.

In various embodiments, a frame may also include extendible and retractable legs. The legs may be extended to lift the frame above the track and also above the trailer. This may allow for easy unloading of the frame and the material that the frame is holding. After lifting the frame, the transport may be removed leaving the frame standing on the extending legs, which may then be retracted. In various embodiments, a material loader such as a forklift may be used to load and unload frame on to the track (on the transport).

In various embodiments, one or more tracks may be mounted vertically, for example on a wall. In some of these embodiments, the inner and outer part of clamping mechanism may be attached to a tool holder, a shelf, folding work bench, lighting, entertainment devices, TVs, speakers, sporting equipment racks, bike rack, garden tool rack, kayak rack, ladder fork, etc.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phases are not generally intended to, and should not, imply that certain embodiments require at least one of either X, Y, or Z to be present, but not, for example, one X and one Y. Further, such phases should not imply that certain embodiments require each of at least one of X, at least one of Y, and at least one of Z to be present.

A first aspects of the disclosure includes a device comprising: at least one track, the at least one track having a length along a length axis, a height along a height axis, a width along a width axis, an inner surface parallel to the length and height axes, an outer surface parallel to the inner surface, the at least one track having a base portion and a plurality of ridges that extend along the height axis from a top surface of the base portion, wherein a first surface of the base portion is oblique to a bottom surface of the base portion and to the inner surface, and wherein a first surface of each ridge of the plurality of ridges is oblique to the outer surface and to a top surface of that ridge; and a clamping mechanism to removably attach to the at least one track, the clamping mechanism comprising an inner part and an outer part, wherein the outer part, when clamped, is in contact with the first surface and the top surface of at least one ridge, and wherein the inner part, when clamped, is in contact with the first surface of the base portion and the inner surface.

A second aspect of the disclosure includes a device wherein a first gap is formed between a first ridge of the plurality of ridges and a second ridge of the plurality of ridges, the first gap having a first width near the top surface of the base portion and a second width near the top surfaces of the first ridge and the second ridge.

A third aspect of the disclosure includes a device wherein the second width is greater than the first width.

A fourth aspect of the disclosure includes a device further comprising an opening through the base portion from the bottom surface of the base portion to the first gap.

A fifth aspect of the disclosure includes a device, further comprising a frame attached to the outer part.

A sixth aspect of the disclosure includes a device wherein the inner part further comprises a pin extending in a direction parallel to the height axis and extending through an opening in the frame.

A seventh aspect of the disclosure includes a device wherein the frame is configured to receive a material transport container.

An eighth aspect of the disclosure includes a device wherein the frame is configured to receive a boat.

A nineth aspect of the disclosure includes a device wherein the frame is removably attached to a transport.

A tenth aspect of the disclosure includes a device wherein the transport is a bed of a truck.

An eleventh aspect of the disclosure includes a device wherein the transport is a trailer.

A twelfth aspect of the disclosure includes a device further comprising a material transport container, wherein the material transport container further comprises at least two openings and at least two support extensions.

A thirteenth aspect of the disclosure includes a device wherein a first opening of the two openings is larger than a second opening of the two openings, and wherein the first opening is on a first side of the container and the second opening is on a second side of the container that is opposite to the first side.

A fourteenth aspect of the disclosure includes a device further comprising at least one piston attached to the frame and the material transport container, wherein when the at least one piston is in a retracted position, the support extensions of the material transport container rests on support points on the frame.

A fifteenth aspect of the disclosure includes a device wherein a first opening of the at least two openings and a first support extension of the at least two support extensions is on a first side of the material transport container, and wherein a second opening of the at least two openings and a second support extension of the at least two support extensions is on a second side of the material transport container, and wherein the first side is opposite to the second side.

A sixteenth aspect of the disclosure includes a device a material transport container comprising at least two openings and at least two support extensions; at least one piston; and a frame comprising at least two support points, wherein the at least one piston is attached to the material transport container and the frame, and wherein the at least two support extensions rest on the at least two support points when the piston is in a closed position.

A seventeenth aspect of the disclosure includes a device wherein a first opening of the at least two openings and a first support extension of the at least two support extensions are on a first side of the material transport container, and wherein a second opening of the at least two openings and a second support extension of the at least two support extensions are on a second side of the material transport container, and wherein the first side is opposite to the second side.

An eighteenth aspect of the disclosure includes a device wherein the frame further comprises at least two locking mechanisms in proximity to the at least two support points, wherein locking the at least two locking positions locking the at least two support extensions to the at least two support points.

A nineteenth aspect of the disclosure includes a device wherein locking a first of the at least two support points and extending the piston causes the container to tilt to the first side, and wherein locking a second of the at least two support points and extending the piston causes the container to tilt to the second side.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

1. A device comprising:
at least one track, the at least one track having a length along a length axis, a height along a height axis, a width along a width axis, an inner surface parallel to the length and height axes, an outer surface parallel to the inner surface, the at least one track having a base portion and a plurality of ridges that extend along the height axis from a top surface of the base portion, wherein a first surface of the base portion is oblique to a bottom surface of the base portion and to the inner surface, and wherein a first surface of each ridge of the plurality of ridges is oblique to the outer surface and to a top surface of that ridge; and
a clamping mechanism to removably attach to the at least one track,
the clamping mechanism comprising an inner part and an outer part, wherein the outer part, when clamped, is in contact with the first surface and the top surface of at least one ridge, and wherein the inner part, when clamped, is in contact with the first surface of the base portion and the inner surface.

2. The device of claim 1, wherein a first gap is formed between a first ridge of the plurality of ridges and a second ridge of the plurality of ridges, the first gap having a first width near the top surface of the base portion and a second width near the top surfaces of the first ridge and the second ridge.

3. The device of claim 2, wherein the second width is greater than the first width.

4. The device of claim 2, further comprising an opening through the base portion from the bottom surface of the base portion to the first gap.

5. The device of claim 1, further comprising a frame attached to the outer part.

6. The device of claim 5, wherein the inner part further comprises a pin extending in a direction parallel to the height axis and extending through an opening in the frame.

7. The device of claim 5, wherein the frame is configured to receive a material transport container.

8. The device of claim 5, wherein the frame is configured to receive a boat.

9. The device of claim 5, wherein the frame is removably attached to a transport.

10. The device of claim 9, wherein the transport is a bed of a truck.

11. The device of claim 9, wherein the transport is a trailer.

12. The device of claim 5, further comprising a material transport container, wherein the material transport container further comprises at least two openings and at least two support extensions.

13. The device of claim 12, wherein a first opening of the two openings is larger than a second opening of the two openings, and wherein the first opening is on a first side of the material transport container and the second opening is on a second side of the material transport container that is opposite to the first side.

14. The device of claim 12, further comprising at least one piston attached to the frame and the material transport container, wherein when the at least one piston is in a retracted position, the support extensions of the material transport container rests on support points on the frame.

15. The device of claim 14, wherein a first opening of the at least two openings and a first support extension of the at least two support extensions are on a first side of the material transport container, and wherein a second opening of the at least two openings and a second support extension of the at least two support extensions is on a second side of the material transport container, and wherein the first side is opposite to the second side.

16. A device comprising:
a material transport container comprising at least two openings and at least two support extensions;
at least one piston; and
a frame comprising at least two support points, wherein the at least one piston is attached to the material transport container and the frame, and wherein the at least two support extensions rest on the at least two support points when the piston is in a closed position.

17. The device of claim 16, wherein a first opening of the at least two openings and a first support extension of the at least two support extensions are on a first side of the material transport container, and wherein a second opening of the at least two openings and a second support extension of the at least two support extensions are on a second side of the material transport container, and wherein the first side is opposite to the second side.

18. The device of claim 17, wherein the frame further comprises at least two locking mechanisms in proximity to the at least two support points, wherein locking the at least two locking positions locking the at least two support extensions to the at least two support points.

19. The device of claim 18, wherein locking a first of the at least two support points and extending the piston causes the material transport container to tilt to the first side, and wherein locking a second of the at least two support points and extending the piston causes the material transport container to tilt to the second side.

20. A method of securing a frame to at least one track, the method comprising:
placing the frame over the at least one track, wherein when placed, an outer part attached to the frame is in contact with at least a portion of an outer surface of the at least one track;
sliding an inner part after placing the frame on the at least one track, such that the inner part is in contact with at least a portion of an inner surface of the at least one track; and
securing the inner part with the frame.
